(19) United States
(12) Patent Application Publication
(10) Pub. No.: US 2010/0282352 A1
(43) Pub. Date: Nov. 11, 2010

(54) Integrated graphical containment structure

(75) Inventors: H. Winston Maue, Farmington Hills, MI (US); Jeff A. Kempf, Sterling Heights, MI (US); Terri L. Tahnoose, West Bloomfield, MI (US); Assi Grossman, Clawson, MI (US)

Correspondence Address: H. WINSTON MAUE, 21789 GLENWILD DRIVE, NORTHVILLE, MI, 48167, US

(73) Assignee: SOLUTION FINDERS LLC

(21) Appl. No.: 12/800,025

(22) Filed: May 6, 2010

Related U.S. Application Data
(60) Provisional application No. 61/215,762, filed on May 8, 2009.

(51) Int. Cl. F16L 55/00

(52) U.S. Cl. 138/104; 138/108; 138/110; 174/482

(57) ABSTRACT

A clear plastic member is formed to provide channels to contain service cords and utilities. The center channel most generally will contain the power cord. The channels on each side of the center channel are of smaller cross section and may include data, communication, and utility applications in any combination. Central and part of the extruded member is a cavity that transverses the entire top area of the member. The application of this cavity is to encapsulate a pattern representative of the floor, wall, veiling, or desk that the device is being mounted to, or this cavity could also contain graphical details including the logo of the company, legends, and other customized details to provide complimentary graphical details with the power, communication, data, or utility services.

### CROSS REFERENCE TO RELATED APPLICATIONS

This application claims priority from U.S. Provisional Application Ser. No. 61/215,762, filed May 8, 2009, the disclosure of which is incorporated herein in its entirety by reference.

### FEDERALLY SPONSORED RESEARCH AND DEVELOPMENT

This application contains no federal sponsored research or development.

### BACKGROUND OF THE INVENTION

The objective of the invention is to provide a method to route and graphically complement service cords and utility services transferred across, a floor, ceiling, wall or desk. The service cords can include power, data, and communication applications. Additionally, utility services such as hydraulic, pneumatic, and vacuum services are included.

Both residential and commercial applications exist for this device. In a residence, the routing of a table lamp cord across carpet, tile or a wood floor is an example of an application which requires both mechanical protection and blending with the mating surface. Commercial applications include retail buildings, offices, educational facilities, healthcare facilities, museums, stadiums, offices and trade shows. In such applications, the location of the service cord or utility source is frequently remote from the user location and requires both mechanical protection and graphics to complement the surrounding mounting medium.

Permanent alternatives to route service cords or utilities require physical modifications to the related structures. This involves hiring tradesmen and costly permanent structural modifications and does not provide convenient modifications as requirements change.

The products available commercially are primarily large, bulky, rubber or plastic covers that come in limited colors. Other products are of multi piece design to encapsulate a graphical insert. All of these designs require an additional feature to attach or prevent slippage with an adjacent surface.

The subject invention represents a one piece design with integrated attachment features and a containment recess for graphical inserts.

### RELATED ART

U.S. Pat. No. 4,258,515, issued to Owen, discloses an extruded plastic protective structure adapted to cover, conceal, and protect cables or conduits. Presented in several embodiments, the protector consists of a base and a cover. The base is formed of plastic and includes a surface or web adapted for mounting to a supporting surface. The base further includes upstanding ribs defining a channel in which a cable or other such utility is to be positioned. The cover overlies the channel and provides protection to an enclosed cable or cord. The cover is also designed with a groove along each internal edge facilitating the insertion of decorative materials beneath the plastic cover as desired.

U.S. Pat. No. 3,118,017, issued to Wimbish, shows a receptacle for electrical conduits and like utilities designed to enclose and protect the conduit. The protector is formed as a unitary plastic body defined by an elongated hollow body having a transversely rounded upper surface. A plurality of plastic ribs, depending from the upper surface, act as support legs for the protector and are provided with lateral projections that serve to receive and support cable extending through the protector.

U.S. Pat. No. 6,202,565 B1, issued to Henry et al., describes a device designed and constructed to protect cable. The device is presented as a modular unit having connecting means at each end such that multiple units may be connected together in series. The device includes suitable passageways for the receipt of cables to be protected.

U.S. Pat. No. 4,454,374, issued to Poliack, is directed towards an electrical cord extruded from plastic and designed to receive electrical cords and be attached to a supporting surface by means of a securing strip.

U.S. Pat. No. 5,675,125, issued to Hollinger, describes a multiple component electrical outlet box covering. A graphical insert is positioned between a transparent cover plate and a metallic base plate in the absence of screws to form a decorative structure.

U.S. Pat. No. D445,093, issued to Staskey, describes a decorative electric cord cover consisting of a one-piece sleeve, imprinted with graphics, for concealment of an electrical cord.

### SUMMARY OF THE INVENTION

This invention relates to service cord and utility service management. Typically these services are routed across floors, walls, and ceilings in unorganized fashion. Temporary containment of these conduits is cumbersome and unattractive.

The intent of this invention is to provide a simple and economical one piece member to temporarily route and graphically complement these services for both commercial and residential applications.

The invention relates generally to protective cover assemblies. More specifically, the invention is a protective cover for electrical cords, cables and utility elements requiring protection. The invention consists of a one piece, transparent plastic member that includes a recesses or channels adapted to receive the elements requiring physical protection. Intended to protect the elements from pedestrian traffic and other physical contact, the structure is adapted for use on floors, walls, ceilings, and furniture. Capable of being offered in several variations, the structure may be configured as plastic tracks capable of being interconnected end-to-end and constructed with a slot or channel. All variations are designed to receive decorative patterned or colored graphical inserts so that the cover will complement its surrounding environment. In the single piece embodiment, a plastic member is formed to include spaced mounting feet for engaging a supporting surface and will include channels to contain service cords and utilities. A mounting transition plate contains features to captivate the channels for attachment to an adjacent surface.

Various objects and advantages of this invention will become apparent to those skilled in the art from the following detailed description of the preferred embodiment, when read in light of the accompanying drawings.

### BRIEF DESCRIPTION OF THE DRAWINGS

FIG. 1 is a perspective view of an electrical cord or utility service transversing a surface within the structure and complimenting graphical insert application.

FIG. 2 is a sectional view showing the inherent features of the structure

FIG. 3 is a perspective view of a mounting transition plate with continuous ribs.

FIG. 4 is a perspective view of a mounting transition plate with discontinuous ribs.

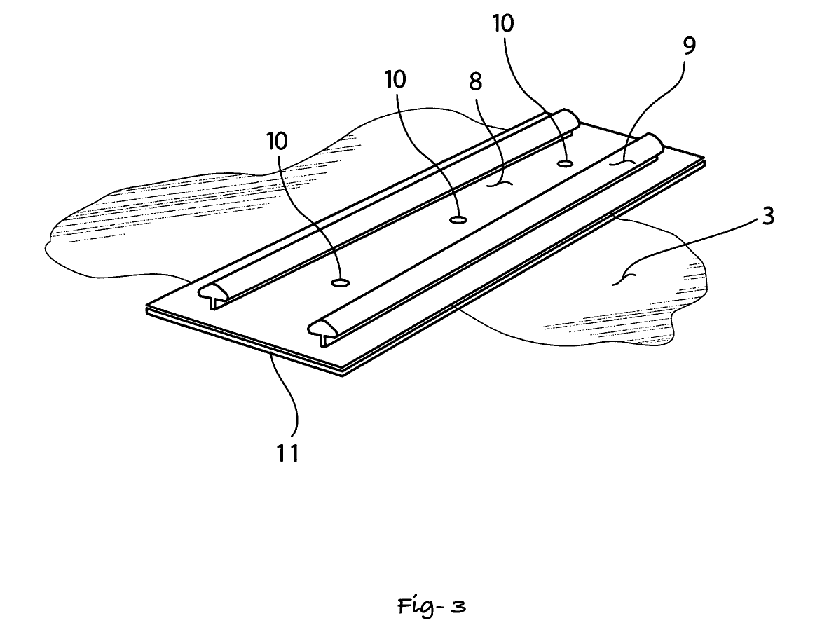

FIG. 3 is a perspective view illustrating the assembly of the containment structure with the transition mounting plate.

### DETAILED DESCRIPTION OF THE INVENTION

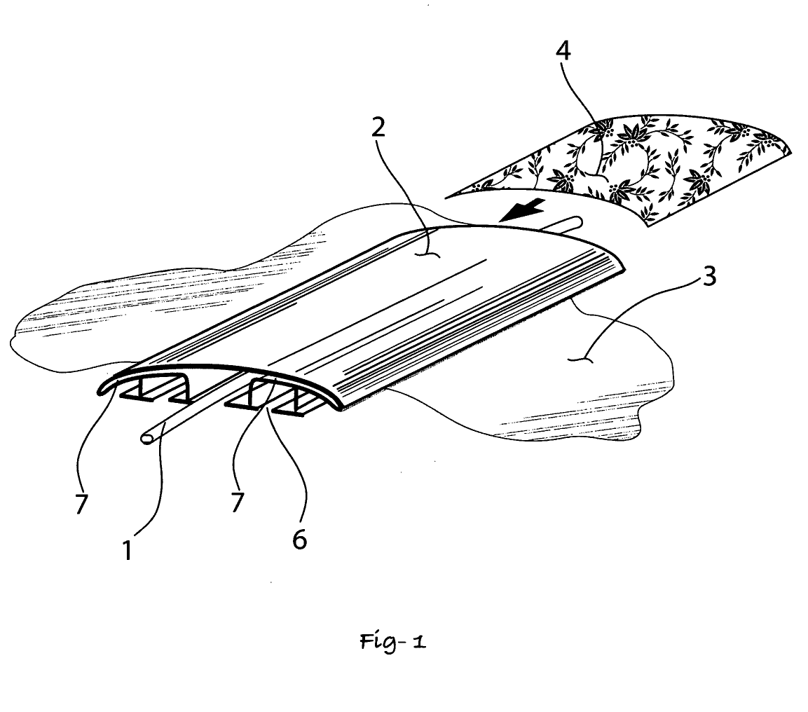

The illustration in FIG. 1 depicts a service cord or utility 1 in close proximity with surface 3. The service cord or utility 1 represents power, data, and communication, pneumatic, vacuum, or hydraulic services. The containment structure 2 includes a recess 7 to accept a graphical insert 4 to compliment its proximity with surface 3. Surface 3 could be a wall, ceiling, floor, desk, table, or any other planer mounting surface.

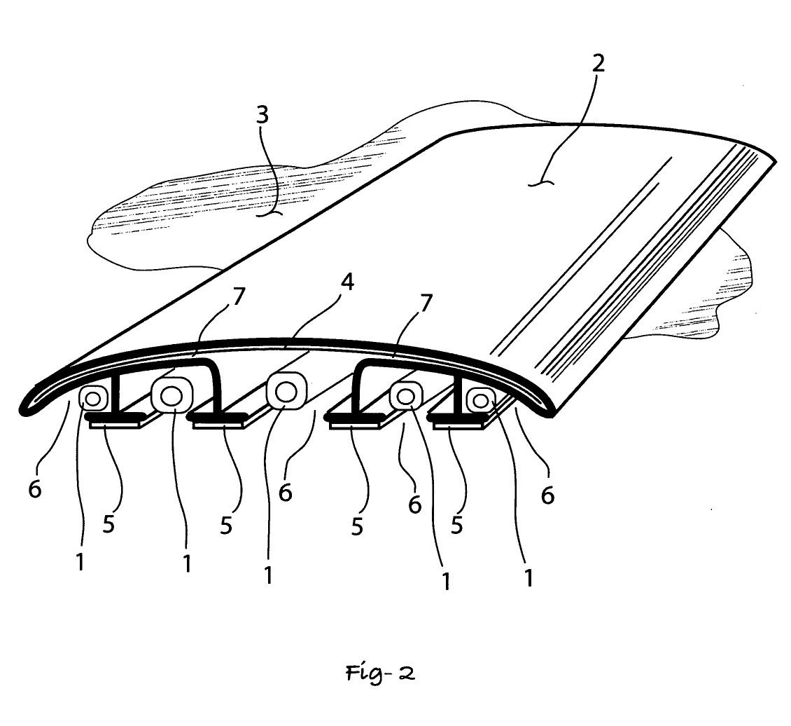

The sectional view shown in FIG. 2 illustrates various features of the invention. A clear, transparent, or opaque containment structure 2 includes features to route service cords or utilities 1 and a recess 7 spanning the upper surface to retain a graphical insert 4. The graphical insert 4 is designed to visually contrast, camouflage, or complement with surface 3. Multiple channels 6 within the containment structure 2 allow routing service cords or utilities 1. A non-slip material 5 prevents the containment structure 2 from sliding or moving with respect to surface 3. The non-slip material 5 could include, but not limited to, Velcro or double-sided tapes in addition to soft PVC resin integral with the containment structure 2.

FIG. 3 depicts an alternative mounting method. A transition plate 8 contains a feature 9 for captivation within channel 6 of the containment structure 2 shown in FIG. 2. Mounting feature 9 consists of continuous tabs formed from the material of the plate. The opposite side of the transition plate 8 provides a mounting surface for Velcro, double-sided tape or adhesives 11 for mounting to an adjacent surface 3 shown in FIG. 2. Additionally, holes 10 are integral within the transition plate 8 for mechanical attachment with surface 3 shown in FIG. 2 using fasteners, but not limited to screws and bolts.

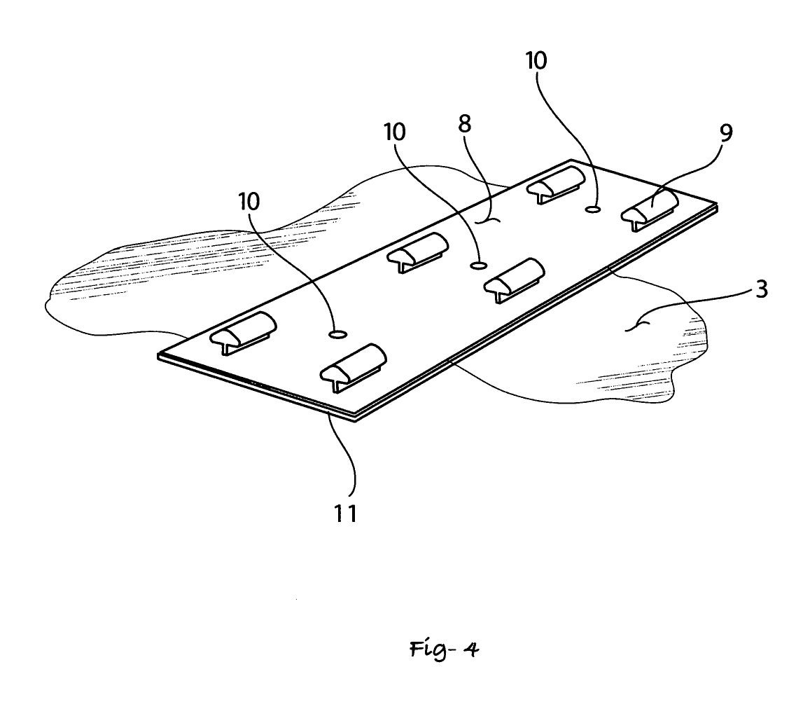

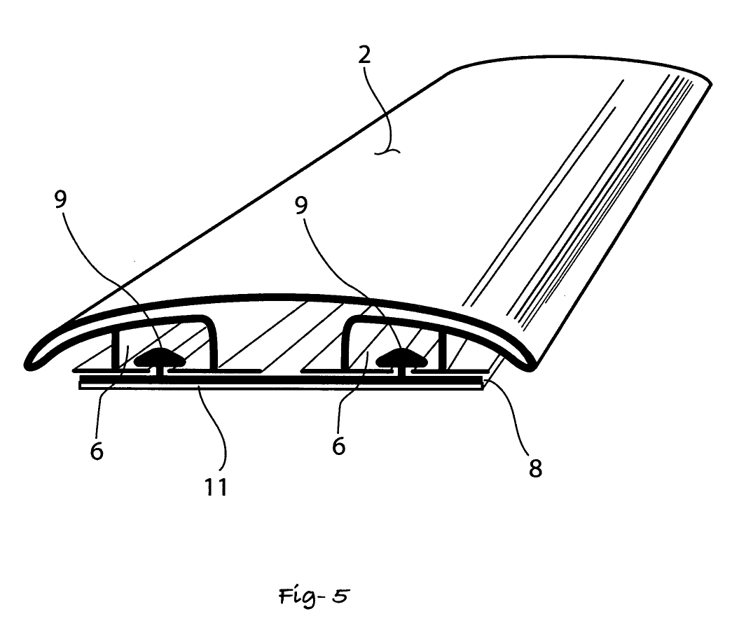

FIG. 4 demonstrates intermittent, discontinuous mounting tabs as the attachment means with the channel 6 of the containment structure 2 of FIG. 2. The manufacturing process determines if the mounting tabs 9 of FIG. 3 or FIG. 4 are continuous or discontinuous. Extruded transition plates will typically have continuous mounting tabs and molded transition plates will have discontinuous mounting tabs. Holes 10 are provided for mechanical attachment with a mounting surface. The transition plates of FIG. 3 and FIG. 4 are not limited to either metallic or plastic construction.

FIG. 5 illustrates the attachment method. The mounting tabs 9 of the transition plate 8 are received by the channels 6 within the containment structure 2. The attachment means 11 is Velcro, double-sided tape, or other adhesive mounting means.

The extrusion of plastics is known technology. The selection of the plastic resin to be extruded is unlimited. Visually, both clear and frosted surfaces of the extruded channel are applicable. Additionally, the components could be molded.

What is claimed is:

1. A cover assembly, comprising:
a graphical insert, and
a plastic cover,
wherein the plastic cover has a recess adapted to receive a graphical insert.

2. The cover assembly of claim 1, wherein the graphical insert is embossed or printed with a pattern.

3. The cover assembly of claim 1, wherein the graphical insert is colored.

4. The cover assembly of claim 1, wherein the plastic cover consists of a plastic resin.

5. The cover assembly of claim 1, wherein the plastic cover is either transparent or opaque.

6. The cover assembly of claim 1, wherein the plastic cover is extruded or molded plastic.

7. The cover assembly of claim 1, further comprising:
a channel to receive a utility or service element.

8. The cover assembly of claim 7, wherein the plastic cover has one or more channels to receive a utility element, service element, power cord, data cord, communication cord, pneumatic cord, vacuum cord, or hydraulic cord.

9. The cover assembly of claim 1, further comprising:
a means of attaching the cover assembly to an underlying surface.

10. The cover assembly of claim 9, wherein the means of attaching may include Velcro or double sided tape.

11. A cover assembly, comprising:
a graphical insert,
a plastic cover,
wherein the plastic cover has a recess adapted to receive a graphical insert, and
wherein the plastic cover has a channel to receive a utility or service element, and
wherein the plastic cover has one or more further channels to attach to a transition plate; and
a transition plate,
wherein the transition plate has a mounting feature for attachment to the plastic cover, and
wherein the transition plate has a means to attach to an underlying surface.

12. The cover assembly of claim 11, wherein the graphical insert is embossed or printed with a pattern.

13. The cover assembly of claim 11, wherein the graphical insert is colored.

14. The cover assembly of claim 11, wherein the plastic cover and the transition plate consists of a plastic resin.

15. The cover assembly of claim 11, wherein the plastic cover and the transition plate are either transparent or opaque.

16. The cover assembly of claim 11, wherein the plastic cover and the transition plate are either extruded or molded plastic.

17. The cover assembly of claim 11, wherein the plastic cover has one or more channels to receive a utility element, service element, power cord, data cord, communication cord, pneumatic cord, vacuum cord, or hydraulic cord.

18. The cover assembly of claim 11, wherein the means to attach the transition plate to the underlying surface may include Velcro, double sided tape, fasteners, screws, or bolts.

19. A cover assembly, comprising:
a graphical insert, and
a plastic cover,
wherein the plastic cover has a recess adapted to receive a graphical insert, and
wherein the plastic cover has one or more channels to receive a utility or service element,
wherein the plastic cover has a means of attaching the cover assembly to an underlying surface.

20. The cover assembly of claim 19, wherein the means of attaching the cover assembly to an underlying surface includes an attached transition plate, Velcro, double sided tape, fasteners, screws, or bolts.
